(19) United States
(12) Patent Application Publication
(10) Pub. No.: US 2006/0189343 A1
(43) Pub. Date: Aug. 24, 2006

(54) Method for forming power-efficient network

(75) Inventor: Woo-jong Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/354,922

(22) Filed: Feb. 16, 2006

(30) Foreign Application Priority Data
Feb. 18, 2005 (KR) 2005-0013780

(51) Int. Cl. H04B 7/00; H04Q 7/20

(52) U.S. Cl. 455/522

(57) ABSTRACT

A method for forming a power-efficient network in a wireless sensor network including allowing a device connected to a first coordinator which configures a first wireless network to apply receiving-end power of the device for a predetermined time period intermittently; allowing the device to which the receiving-end power is applied to receive a beacon signal transmitted from a second coordinator which configures a second wireless network; and allowing the device to operate as a router after receiving the beacon signal. It extends a network effectively, while minimizing power consumption of a node, and extends the lifetime of a network by minimizing power consumption of node.

### CROSS-REFERENCE TO RELATED APPLICATIONS

This application claims priority from Korean Patent Application No. 2005-13780, filed on Feb. 18, 2005, the entire content of which is incorporated herein by reference.

### BACKGROUND OF THE INVENTION

1. Field of the Invention

Methods consistent with the present invention relate forming a network in a wireless sensor network and, more specifically, forming a power efficient network in a wireless sensor network.

2. Description of the Related Art

A wireless sensor network can be simply defined as a number of sensors connected to a network in a wireless scheme. That is, wireless network technology refers to a technology capable of forming a self-controlled network by randomly disposing sensor nodes having functions of computing and wireless communication in a natural environment or a battlefield, transmitting and receiving sensing information obtained by the wireless sensor network among the sensor nodes, and being remotely utilized via a network for the purpose of monitoring/controlling. The ultimate purpose of such a wireless sensor network is to realize a ubiquitous environment capable of communicating among aspects in “whenever” and “wherever” by endowing all aspects with the functions of computing and wireless communication. The sensor node in the wireless sensor network transfers information sensed in a sensor to a base station which serves as a gateway, and the base station in turn transfers the information to users who need it through the network.

Low power consumption in the sensor node is needed to construct such a wireless network. In order to embody the ubiquitous computing technique emerging as a social issue recently, it is necessary to extend the wireless network. However, to extend the network in an existing Personal Area Network (PAN), it is inevitable to consume power in each node. Since it cannot be assumed that power is continuously provided in a low power wireless communication network such as ubiquitous sensor network (USN), the amount of power consumed in each node becomes an important factor to determine the lifetime of the network.

FIG. 1 is a view explaining construction and function of PAN. The network communication under PAN environment is performed by a PAN coordinator 100, a PAN router 130 and a PAN device 160. Here, the PAN coordinator 100 uses a routine to integrate time and operation, which determines operations performed in a clock level and a base level depending on a period. The router 130 is a device which connects a plurality of local area networks (LANs) with one another so as to give and take data among them. Although the router 130 basically has the same function as a bridge, it makes a path selection at a network layer (third layer) of an OSI basic reference model, so that a plurality of LANs are interconnected with each other by a logic link control (LLC) protocol and a media access control (MAC) protocol.

While the bridge determines whether it passes data or not, the router analyzes protocols included in the data, selects the optimum path and transmits the data. That is, the router has a function to transmit data to another router or other devices as well as the transmission function. Meanwhile, the device 160 does not have the function to transmit data to other routers or other devices. In case that there is a coordinator and a device to form a network, there are two methods for utilizing the device, that is, a method utilizing the device as a router, and a method utilizing the device merely as a device.

FIG. 2A is a view showing an example of a network that consists of a coordinator and devices in a network forming method. In the case of the coordinator 200 being connected to the devices 220 only, as shown in FIG. 2A, since each device 220 does not have a transmission function, two adjacent networks have a problem since they do not have extendability. In order to solve such a problem, all devices in the art used to construct the network were embodied to function as a router.

FIG. 2B is a view showing an example of network consisting of a coordinator and routers in a network forming method. However, operation of the device as a router 210 without correct information on a type of network or external control as shown in FIG. 2 leads to a large amount of power consumption in maintaining and extending the network.

FIG. 2C is a view which shows a problem that occurs in a network consisting of a coordinator and a router in a network forming method. FIG. 2C shows constructional elements of be network are relocated to reflect a network property shown in FIG. 2B for the purpose of efficient power consumption. In a tree structure shown on the left in FIG. 2C, the nodes, that is, leaf nodes, that do not have descendant nodes, such as node 2, node 4, node 6, node 7, node 8 and node 9 do not need to be constantly operated on a current network to perform communication.

Accordingly, the routers 210 will consume a low amount of power by operating them as devices 220 as shown in the right tree structure. However, it is not easy to know when to make such a determination and to manage the situation where the nodes are continuously generated and cancelled on the network. Consequently, there is no choice but to operate the network using only routers, which continuously consume power in the art.

### SUMMARY OF THE INVENTION

The present invention provides a method which may form a power efficient network.

According to an aspect of the present invention, there is provided a method for forming a power-efficient network, comprising using receiving-end power for a predetermined time period intermittently by a device connected to a first coordinator which configures a first wireless network; receiving a beacon signal transmitted from a second coordinator which configures a second wireless network by the device in which the receiving-end power is used; and operating the device as a router after receiving the beacon signal.

Further, the method may comprise operating the second coordinator as a router connected to the first coordinator.

Additionally, devices connected to the second coordinator may be connected to the first coordinator as the second coordinator operates as a router.

In the using the receiving-end power, the receiving-end power may be used one or more times during a period of the beacon signal transmitted from the first coordinator.

In the using the receiving-end power, all devices connected to the first coordinator may use the receiving-end power intermittently.

The predetermined time may be a period of the beacon signal transmitted from the first coordinator.

The predetermined time may also be longer than the period of the beacon signal transmitted from the first coordinator.

According to another aspect of the present invention, there is provided a method for forming a power-efficient network, comprising transmitting and adjacent network searching signal by a device connected to a first coordinator which configures a first wireless network; receiving the network searching signal by a device connected to a second coordinate which configures a second wireless network; operating the device connected to the second coordinator as a router when receiving a beacon signal from the second coordinator, after receiving the network searching signal; and operating the device connected to the first coordinator which has transmitted the network searching signal as a router in case that the device connected to the second coordinator operates as a router, the network searching signal being received by the device connected to the second coordinator.

The operating of the device connected to the second coordinator as a router may be performed by a signal conflict between the network searching signal and the beacon signal from the second coordinator.

The method for forming a power-efficient network further comprises operating the second coordinator as a router connected to the first coordinator.

The devices connected to the second coordinator may be connected to the first coordinator as the second coordinator operates as a router.

In the transmitting the adjacent network searching signal by the device, all devices connected to the first coordinator intermittently may transmit other network searching signal at a time.

In the transmitting the adjacent network searching signal by the device, all devices connected to the first coordinator at a time may transmit other network searching signal in a predetermined time interval.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a view explaining construction and function of a PAN;

FIG. 2A is a view showing an example of a network consisting of a coordinator and devices in a network forming method;

FIG. 2B is a view showing an example of network consisting of a coordinator and routers in a network forming method;

FIG. 2C is a view showing a problem of a network consisting of a coordinator and routers in a network forming method;

FIG. 3A is a view showing an operation environment of a method for forming a network in accordance with an exemplary embodiment of the present invention;

FIG. 3B is a view showing an operation result of a method for forming a network in accordance with an exemplary embodiment of the present invention;

FIG. 4 is a view showing an operation principle of a method for forming a network in accordance with an exemplary embodiment of the present invention;

FIG. 5A is a view showing another operation environment of a method for forming a network in accordance with an exemplary embodiment of the present invention;

FIG. 5B is a view showing another operation state of a method for forming a network in accordance with an exemplary embodiment of the present invention;

FIG. 5C is a view showing another operation result of a method for forming a network in accordance with an exemplary embodiment of the present invention;

FIG. 6 is a view showing another operation principle of a method for forming a network in accordance an exemplary embodiment with the present invention.

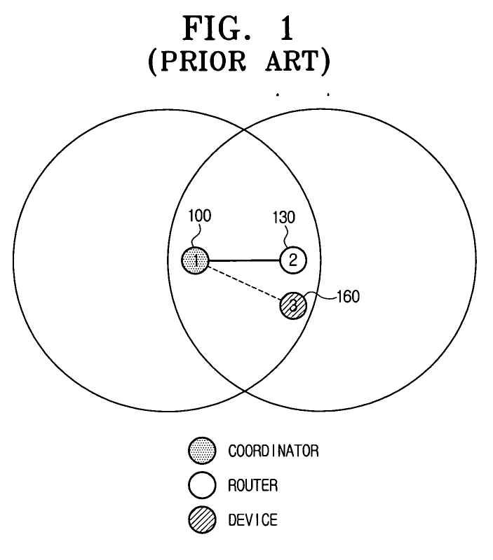

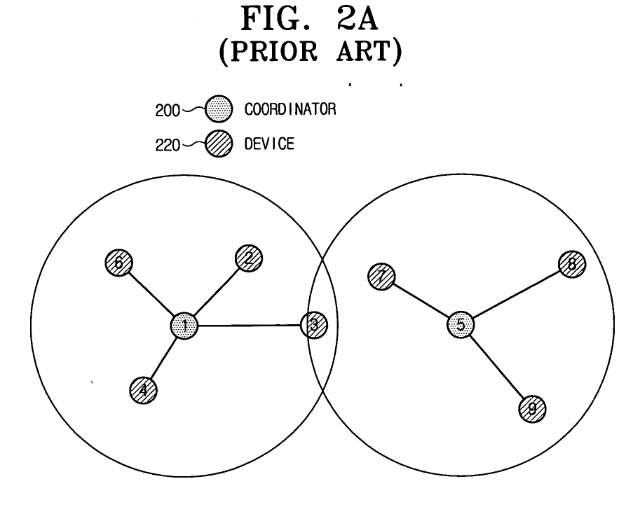

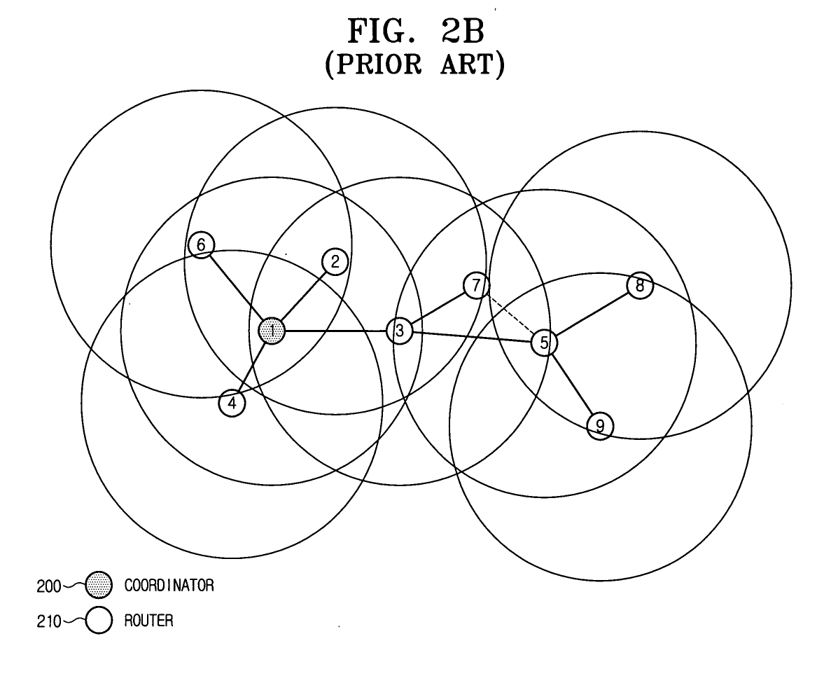

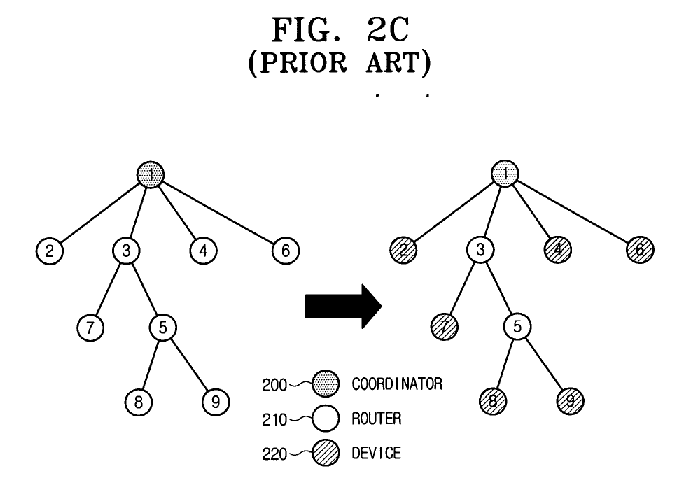

### DETAILED DESCRIPTION OF THE EXEMPLARY EMBODIMENTS

Hereinafter, exemplary embodiments of the present invention will be described in greater detail with reference to the accompanying drawings.

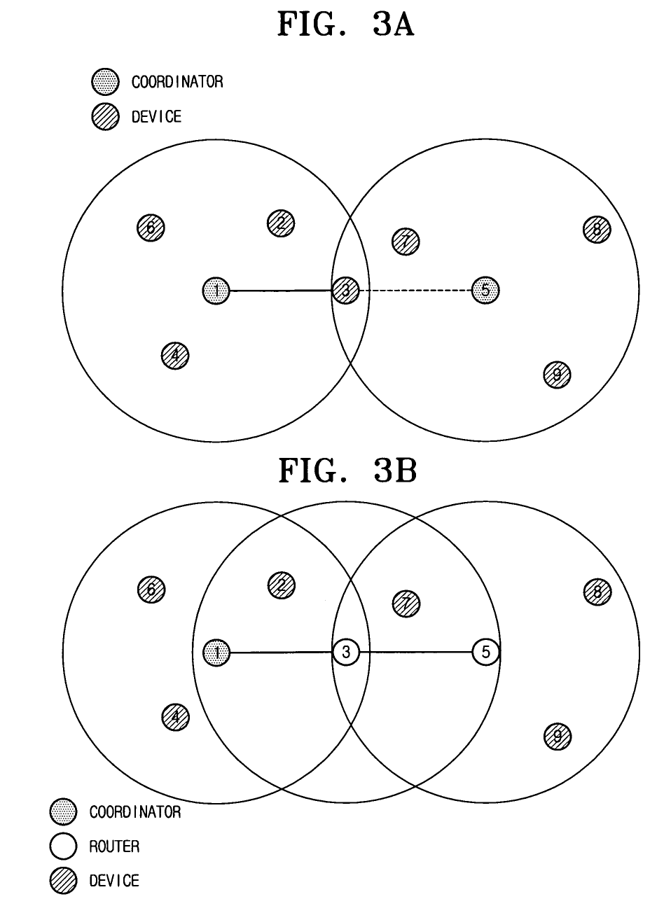

FIG. 3A is a view showing an operation environment of a method for forming a network in accordance with an exemplary embodiment the present invention. Referring to FIG. 3A, a device 2, a device 3, a device 4 and a device 6 are connected to a coordinator 1, and a new coordinator 5 forms a network in an adjacent position. The coordinator 5 is connected to a device 7, a device 8 and a device 9. FIG. 3A shows a case where there exists a device 3 which can receive data from both of the coordinators 1 and 5.

FIG. 3B is a view showing an operation result of a method for forming a network in accordance with the operation environment in FIG. 3A. In case of FIG. 3A, receiving-end power is intermittently used by the device 3 for a predetermined time, and the device 3 resultantly receives a beacon signal from the coordinator 5. The device 3 operates as a router after receiving the beacon signal, and then the coordinator 5 described above operates as a router connected to the coordinator 1. Accordingly, the device 7, device 8 and device 9 that have been connected to the coordinator 5 are connected to the coordinator 1. As a result, an extended network is formed, including the coordinator 1, router 3, router 5, device 2, device 4, device 6, device 7, device 8 and device 9.

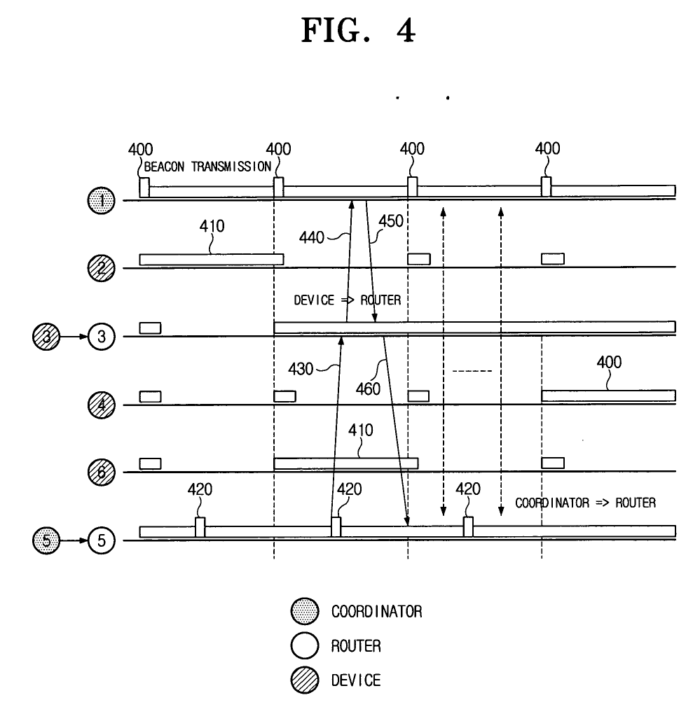

FIG. 4 is a view showing an operation principle of a method for forming a network in accordance with an exemplary embodiment of the present invention.

Referring to FIG. 4, a coordinator 1 initially transmits a beacon signal 400 according to the predetermined period. Meanwhile, a device 2, a device 3, a device 4 and a device 6 connected to the coordinator 1 use receiving-end power intermittently for the period of the beacon signal (410), so that power consumed in the devices is reduced.

Further, the coordinator 5 of a network that is newly formed in an adjacent position transmits a beacon signal 420 according to a predetermined period. The device 3 receives the beacon signal 420 from the coordinator 5 while using the receiving-end power, and it operates as a router 3, afterward. The router 3 transmits the received beacon signal 420 to the coordinator 1 (440), and then the coordinator 1 transmits a response signal to the router 3 (450). The router 3 transmits the received response signal described above to the coordinator 5 (460), and the coordinator 5 that has received the response signal described above operates as a router 5.

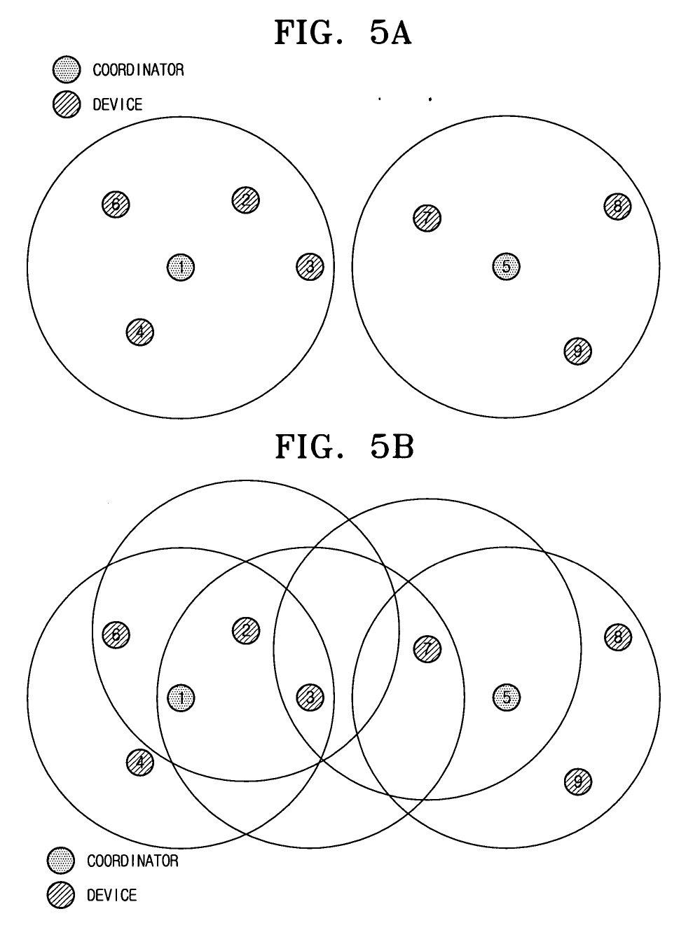

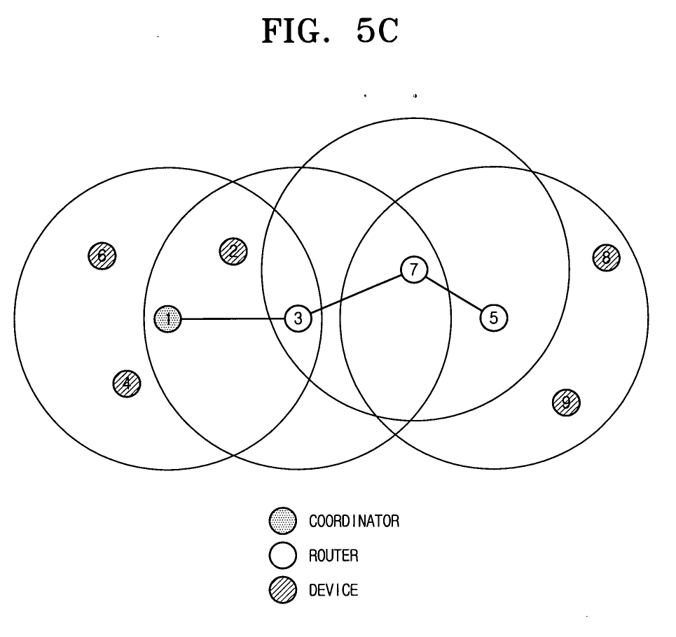

FIG. 5A is a view showing another operation environment of a method for forming a network in accordance with an exemplary embodiment of the present invention. Referring to FIG. 5A, a device 2, a device 3, a device 4 and a device 6 are connected to the coordinator 1, and a new coordinator 5 is formed in an adjacent position. The coordinator 5 is connected to a device 7, a device 8 and a device 9. FIG. 5A shows a case where a device which can receive data from both of the coordinators 1 and 5 does not exist. It is not possible to connect two PANs using the method described in FIG. 4 in the situation in FIG. 5A.

FIG. 5B is a view showing another operation state of a method for forming a network in accordance with an exemplary embodiment of the present invention. However, in the case of FIG. 5A described above, two PANs can be connected through the devices 3 and 7 that operate as an intermediate node between the two PANs.

FIG. 5C is a view showing another operation result of a method for forming a network in accordance with an exemplary embodiment of the present invention. In case of FIG. 5B described above, the device 3 intermittently transmits an adjacent network searching signal. The device 7 connected to the coordinator 5 forming the adjacent network receives the network searching signal described above, and then the device 7 operates as a router when it receives the beacon signal from the coordinator 5. In this case, the device 3 operates as a router, which has transmitted the network searching signal that the device 7 has received, and the coordinator 5 described above operates as a router connected to the coordinator 1. Accordingly, the device 7, device 8 and device 9 that have been connected to the coordinator 5 described above is connected to the coordinator 1. As a result, an extended network is formed, including the coordinator 1, router 3, router 5, router 7, device 2, device 4, device 6, device 8 and device 9.

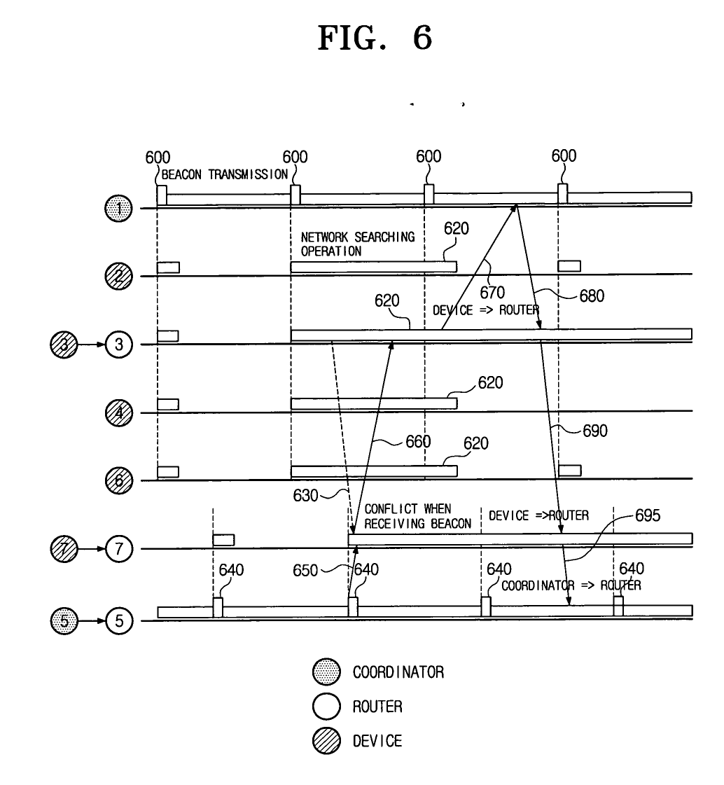

FIG. 6 is a view showing another operation principle of a method for forming a network in accordance with an exemplary embodiment of the.

Referring to FIG. 6, first, the coordinator 1 transmits beacon signals 600 according to a predetermined period. Meanwhile, the device 2, device 3, device 4 and device 6 connected to the coordinator 1 simultaneously transmit different network searching signals 620 in a predetermined time interval. That is, as the devices transmit the network searching signals in the predetermined time interval, power consumption in the devices is reduced. Meanwhile, the device 7 connected to the coordinator 5 of the network which was newly formed in the adjacent position receives the searching signal transmitted from the device 3 described above (630).

The coordinator 5 also transmits beacon signals 640 in a predetermined period. When the device 7 which has received the searching signal transmitted from the device 3 receives the beacon signal 640 transmitted from the coordinator 5 (650), there occurs a conflict between a network searching signal and the beacon signal transmitted from the coordinator 5 in the device 7. Accordingly, the device 7 operates as the router 7, and the router 7 transmits an information signal of its own to the device 3 (660).

The device 3 that has received the information signal described above operates as the router 3, and transmits to the coordinator 1 the information signal transmitted from the router 7 (670). The coordinator 1 transmits the response signal to the router 3 after receiving the information signal described above (680), and the router 3 transmits the response signal to the router 7 (690). The router 7 transmits the response signal transmitted from the router 3, to the coordinator 5 (695). The coordinator 5 receives the response signal transmitted from the router 3 and then operates as the router 5.

As described above, according to the present invention, it is possible to effectively extend the network while minimizing the power consumption of node. Further, as power consumption of the node becomes minimized, it is possible to extend the lifetime of a network remarkably. Simultaneously, it can be possible to meet movement of a device or a device group, or exceptional circumstances including changes such as new setup or removal of the device.

The foregoing embodiments are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method for forming a power-efficient network, the method comprising:
using receiving-end power for a predetermined time period intermittently in a device connected to a first coordinator which configures a first wireless network;
receiving a beacon signal transmitted from a second coordinator which configures a second wireless network by the device in which the receiving-end power is used; and
operating the device as a router after receiving the beacon signal.

2. The method as claimed in claim 1, further comprising operating the second coordinator as a router connected to the first coordinator.

3. The method claimed in claim 2, wherein a plurality of devices connected to the second coordinator are connected to the first coordinator when the second coordinator operates as a router.

4. The method claimed in claim 1, wherein in the using the receiving-end power, the receiving-end power is used at least one time during the period of the beacon signal transmitted from the first coordinator.

5. The method claimed in claim 1, wherein in the using the receiving-end power, all devices connected to the first coordinator use the receiving-end power intermittently.

6. The method claimed in claim 1, wherein the predetermined time is a period of the beacon signal transmitted from the first coordinator.

7. The method claimed in claim 1, wherein the predetermined time is longer than the period of the beacon signal transmitted from the first coordinator.

8. A method for forming a power efficient network, the method comprising:
transmitting an adjacent network searching signal by a device connected to a first coordinator which configures a first wireless network;
receiving the network searching signal by a device connected to a second coordinator which configures a second wireless network;
operating the device connected to the second coordinator as a router when receiving a beacon signal from the second coordinator, after receiving the network searching signal; and
operating the device connected to the first coordinator which has transmitted the network searching signal as a router when the device connected to the second coordinator operates as a router, the network searching signal having been received by the device connected to the second coordinator.

9. The method as claimed in claim 8, wherein the operating the device connected to the second coordinator as a router is performed by a signal conflict between the network searching signal and the beacon signal from the second coordinator.

10. The method as claimed in claim 8, further comprising operating the second coordinator as a router connected to the first coordinator.

11. The method as claimed in claim 10, wherein a plurality of devices connected to the second coordinator are connected to the first coordinator when the second coordinator operates as a router.

12. The method as claimed in claim 8, wherein in transmitting the adjacent network searching signal, all devices connected to the first coordinator intermittently transmit other network searching signal.

13. The method as claimed in claim 8, wherein in the transmitting the adjacent network searching signal, all devices connected to the first coordinator transmit other network searching signal in a predetermined time interval.
